(19) United States
(12) Patent Application Publication
(10) Pub. No.: US 2023/0024650 A1
(43) Pub. Date: Jan. 26, 2023

(54) METHOD AND APPARATUS FOR SELECTING MENU ITEMS, READABLE MEDIUM AND ELECTRONIC DEVICE

(71) Applicant: BEIJING BYTEDANCE NETWORK TECHNOLOGY CO., LTD., Beijing (CN)

(72) Inventor: Wei CHENG, Beijing (CN)

(21) Appl. No.: 17/787,837

(22) PCT Filed: Nov. 3, 2020
(86) PCT No.: PCT/CN2020/126252

§ 371 Date: Jun. 21, 2022

(30) Foreign Application Priority Data
Jan. 2, 2020 (CN) 202010001896.0

(51) Int. Cl. G06F 3/0482; G06F 3/0488; H04M 1/72469

(52) U.S. Cl. CPC G06F 3/0482; G06F 3/0488; H04M 1/72469; H04M 2201/42

(57) ABSTRACT

The present disclosure relates to a method and apparatus for selecting menu items, a readable medium and an electronic device. The method comprises: acquiring a first gesture operation input by a user at any position on a screen; under the condition that the first gesture operation is determined to be a preset gesture operation, displaying a selection interface of the menu items, determining a preset menu item as a target menu item, and setting the display state of the target menu item as a selected state; acquiring a second gesture operation input by the user after the first gesture operation; and according to a gesture trajectory in the second gesture operation, determining the target menu item.

This application claims the priority to the Chinese patent application No. 202010001896.0 filed with the Chinese Patent Office on Jan. 2, 2020 and entitled “METHOD AND APPARATUS FOR SELECTING MENU ITEMS, READABLE MEDIUM AND ELECTRONIC DEVICE”, the entirety of which is hereby incorporated by reference into the present application.

### TECHNICAL FIELD

This disclosure relates to the technical field of interaction, and particularly to a menu item selection method and apparatus, a readable medium and an electronic device.

### BACKGROUND

In the existing interaction mode, under the condition that a plurality of rows of selectable menu items need to be displayed on a screen and a plurality of selectable sub-menu items need to be displayed simultaneously in each row of the selectable menu items, the problem that a user cannot accurately select among the plurality of menu items or sub-menu items directly by clicking with a fingertip often occurs because the screen is too small or the screen is not high in sensitivity. In addition, this problem may also occur in the case of a large screen, for example, in some large-screen self-service machines used in various public places, the user is likely to be not tall enough to click the menu item at the top of the screen. Therefore, in the above situation, the interaction mode of a single click selection cannot meet the interaction requirements under various screens and various application scenarios.

### SUMMARY

The present disclosure aims to provide a menu item selection method and apparatus, a readable medium and an electronic device, which start to select a menu item according to a preset gesture operation inputted by a user at any position on a screen and can also select a target menu item from a plurality of menu items according to a subsequently inputted second gesture operation, so as to solve the problem that the selection of the menu item is not inconvenient to operate due to the influence of the size of the screen and the display position of the menu item.

In a first aspect, the present disclosure provides a menu item selection method, comprising:
acquiring a first gesture operation inputted by a user at any position on a screen;
under the condition that the first gesture operation is judged as a preset gesture operation, displaying a selection interface of menu items, determining a preset menu item as a target menu item, and setting a display state of the target menu item to be a selected state;
acquiring a second gesture operation inputted by the user after the first gesture operation; and
determining the target menu item according to a gesture trajectory in the second gesture operation.

Based on the above technical content, it is able to start to select a menu item directly according to a preset gesture operation inputted by the user at any position on the screen, and to select a target menu item from a plurality of menu items according to a second gesture operation inputted subsequently, so that the problem that the selection of the menu item is not inconvenient to operate due to the influence of the size of the screen and the display position of the menu item can be avoided, which greatly facilitates the selection of the menu item by the user in various application scenarios and with various screen sizes.

In one implementation, the preset gesture operation is that: a swiping distance in a screen preset direction is within a first preset distance range, and after swiping is stopped, a continuous pressing time at a position where swiping is stopped exceeds a first preset duration.

In one implementation, a gesture trajectory between the second gesture operation and the first gesture operation is a continuous trajectory.

Further, by means of the gesture trajectory of the continuous trajectory, it can be further ensured that the acquired second gesture operation is the gesture operation inputted by the user for selecting the menu item in the selection interface of menu items.

In one implementation, the determining the target menu item according to the gesture trajectory in the second gesture operation comprises: determining a moving direction and a moving distance of the gesture trajectory in real time according to the second gesture operation; and updating the target menu item in real time according to the moving direction and the moving distance, and setting the display state of the updated target menu item to be a selected state.

In one implementation, the determining the target menu item according to the gesture trajectory in the second gesture operation comprises: under the condition that the target menu item comprises sub-menu items, displaying the sub-menu items of the target menu item in the selection interface, and determining a preset sub-menu item in the sub-menu items of the target menu item as the target menu item.

In one implementation, the method further comprises: once the first gesture operation is judged as the preset gesture operation, displaying first prompt information on the screen, wherein the first prompt information is used for prompting the user that currently the selection of the menu item has been entered, and the user can continue to input the second gesture operation to select from a plurality of menu items in the selection interface of menu items.

In one implementation, if there are multiple selection interfaces of menu items, multiple different preset gesture operations are set to correspond to the different selection interfaces of menu items one to one.

Further, since different preset gesture operations correspond to the different selection interfaces of menu items, a user can determine to enter the different selection interfaces of menu items by inputting the different preset gesture operations.

In a second aspect, the present disclosure further provides a menu item selection apparatus, comprising:
a first acquisition module configured to acquire a first gesture operation inputted by a user at any position on a screen;
a first processing module configured to, under the condition that the first gesture operation is judged as a preset gesture operation, display a selection interface of menu items, determine a preset menu item as a target menu item, and set a display state of the target menu item to be a selected state;
a second acquisition module configured to acquire a second gesture operation inputted by the user after the first gesture operation; and
a second processing module configured to determine the target menu item according to a gesture trajectory in the second gesture operation.

In one implementation, the preset gesture operation is that: a swiping distance in a screen preset direction is within a first preset distance range, and after swiping is stopped, a continuous pressing time at a position where swiping is stopped exceeds a first preset duration.

In one implementation, a gesture trajectory between the second gesture operation and the first gesture operation is a continuous trajectory.

In a third aspect, the present disclosure further provides a computer readable medium having stored thereon a computer program which, when executed by a processing device, performs the steps of the method as described in the first aspect above.

In a fourth aspect, the present disclosure further provides an electronic device, comprising:
a storage device having a computer program stored thereon;
a processing device configured to execute the computer program in the storage device to implement the steps of the method as described in the first aspect.

In a fifth aspect, the present disclosure further provides a computer program comprising program code for performing the steps of the method as described in the first aspect when said computer program is run by a computer.

In conjunction with the above technical solutions, it is able to start to select a menu item directly according to a preset gesture operation inputted by the user at any position on the screen, and to select a target menu item from a plurality of menu items according to a second gesture operation inputted subsequently, so that the problem that the selection of the menu item is not inconvenient to operate due to the influence of the size of the screen and the display position of the menu item can be avoided, which greatly facilitates the selection of the menu item by the user in various application scenarios and with various screen sizes. By means of the gesture trajectory of the continuous trajectory, it can be further ensured that the acquired second gesture operation is the gesture operation inputted by the user for selecting the menu item in the selection interface of menu items. Once the first gesture operation is judged as the preset gesture operation, first prompt information is displayed on the screen, wherein the first prompt information is used for prompting the user that currently the selection of the menu item has been entered, and the user can continue to input the second gesture operation to select from a plurality of menu items in the selection interface of menu items. Since different preset gesture operations correspond to the different selection interfaces of menu items, the user can determine to enter the different selection interfaces of menu items by inputting the different preset gesture operations.

### BRIEF DESCRIPTION OF THE DRAWINGS

The above and other features, advantages, and aspects of embodiments of the present disclosure will become more apparent in conjunction with the accompanying drawings and with reference to the following specific embodiments. Throughout the drawings, identical or similar reference numbers refer to identical or similar elements. It should be understood that the drawings are schematic and that components and elements are not necessarily drawn to scale. In the drawings:

FIG. 1 is a flow diagram illustrating a menu item selection method according to an exemplary embodiment of the present disclosure;

FIG. 2a is a schematic diagram illustrating a user inputting a first gesture operation according to an exemplary embodiment of the present disclosure;

FIG. 2b is a schematic diagram illustrating displaying a selection interface of menu items after the user inputs the first gesture operation according to an exemplary embodiment of the present disclosure;

FIG. 3 is a flow diagram illustrating a menu item selection method according to yet another exemplary embodiment of the present disclosure;

FIG. 4a is a schematic diagram illustrating a user inputting a second gesture operation according to an exemplary embodiment of the present disclosure;

FIG. 4b is a schematic diagram illustrating displaying sub-menu items of the menu item after the user inputs the second gesture operation according to an exemplary embodiment of the present disclosure;

FIG. 5 is a structural block diagram illustrating a menu item selection apparatus according to an exemplary embodiment of the present disclosure;

FIG. 6 is a schematic structural diagram of an electronic device according to an embodiment of the disclosure.

### DETAILED DESCRIPTION

Embodiments of the present disclosure will be described in more detail below with reference to the accompanying drawings. While certain embodiments of the present disclosure are shown in the drawings, it should be understood that the present disclosure can be implemented in various forms and should not be construed as limited to the embodiments set forth herein. On the contrary, these embodiments are provided for a more complete and thorough understanding of the present disclosure. It should be understood that the drawings and the embodiments of the present disclosure are for exemplary purposes only and are not intended to limit the protection scope of the present disclosure.

It should be understood that various steps recited in method embodiments of the present disclosure can be performed in a different order, and/or performed in parallel. Moreover, the method embodiments can include additional steps and/or omit performing the illustrated steps. The scope of the present disclosure is not limited in this respect.

A term “comprise” and variations thereof as used herein are intended to be open-minded, i.e., “comprising but not limited to”. A term “based on” is “based at least in part on”. A term “one embodiment” means “at least one embodiment”; a term “another embodiment” means “at least one additional embodiment”; and a term “some embodiments” means “at least some embodiments”. Relevant definitions for other terms will be given in the following.

It should be noted that the terms “first”, “second”, and the like mentioned in the present disclosure are only used for distinguishing different devices, modules or units, and are not used for limiting the order or interdependence of the functions performed by the devices, modules or units.

It should be noted that modifications of “one” or “plurality” mentioned in this disclosure are intended to be illustrative rather than restrictive, and that those skilled in the art should appreciate that they should be understood as “one or more” unless otherwise clearly indicated in the context.

The names of messages or information exchanged between devices in the embodiments of the present disclosure are for illustrative purposes only, and are not intended to limit the scope of the messages or information.

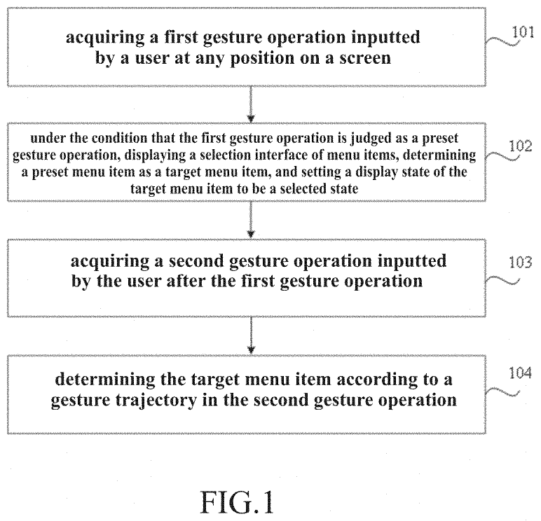

FIG. 1 is a flow diagram illustrating a menu item selection method according to an exemplary embodiment of the present disclosure. As shown in FIG. 1, the method comprises steps 101 to 104.

In step 101, acquiring a first gesture operation inputted by a user at any position on a screen.

In step 102, under the condition that the first gesture operation is judged as a preset gesture operation, displaying a selection interface of menu items, determining a preset menu item as a target menu item, and setting a display state of the target menu item to be a selected state.

The acquiring and judging the first gesture operation is performed in real time. That is, once the user starts to perform gesture input on the screen, the gesture inputted by the user is judged in real time.

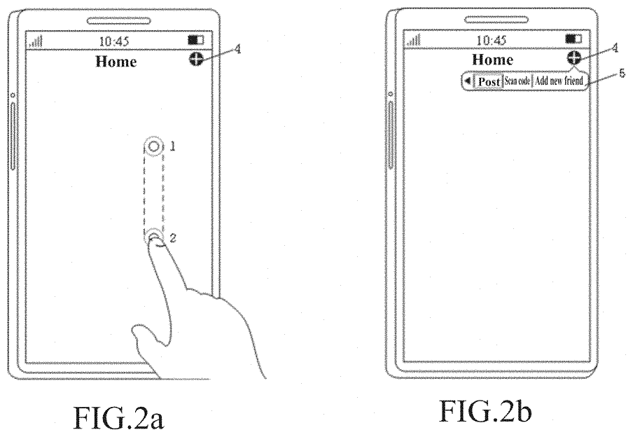

In one possible implementation, the preset gesture operation may be: a swiping distance in a screen preset direction is within a first preset distance range, and after swiping is stopped, a continuous pressing time at a position where swiping is stopped exceeds a first preset duration. For example, as shown in FIG. 2a, if the user starts to swipe down to a contact point 2 from a contact point 1 on the screen, a distance between the contact point 1 and the contact point 2 is within the first preset distance range, and the continuous pressing time at the position of the contact point 2 exceeds the first preset duration, then it maybe immediately judged that the gesture operation inputted by the user and shown in FIG. 2 is the first preset gesture operation once the continuous pressing time at the position of the contact point 2 by the user exceeds the first preset duration. The first predetermined distance range may be, for example, 250 px to 350 px, and the first predetermined duration may be, for example, 2 s.

The preset gesture operation may also be other gesture operations, as long as the first gesture operation inputted by the user can be compared with the preset gesture operation in real time when the first gesture operation is received.

Under the condition that the first gesture operation is judged as the preset gesture operation, the fact that the user needs to select a menu item in the current page can be determined, therefore, a selection interface of menu items in which the user needs to select is displayed in the current display interface, a preset menu item in the selection interface is directly determined as the target menu items, and its display state is set to be a selected state. For example, as shown in FIG. 2b, after receiving the preset gesture operation shown in FIG. 2a, a selection interface 5 of menu items hidden in a function key 4 in the current display interface is displayed, and the display state of the preset menu item “post” therein is set to a selected state as shown in FIG. 2b to distinguish it from other menu items.

In addition, the selection interface 5 of menu items may also be displayed in the current display interface all the time, and after receiving the preset gesture operation inputted by the user, the preset menu item “post” in the selection interface 5 of menu items may be directly determined as a target menu item, and the display state thereof is set to a selected state.

In a possible implementation, if there are multiple selection interfaces of menu items in the current display interface, for example, in the case that there are two or more function keys 4 in which selection interfaces of menu items are hidden in FIG. 2a, multiple different preset gesture operations may be set to correspond to the different selection interfaces of menu items one to one, that is, the preset gesture operation may include multiple gesture operations, for example, a first preset gesture operation, a second preset gesture operation, and the like, and the selection interface of menu items corresponding to the first preset gesture operation is different from the selection interface of menu items corresponding to the second preset gesture operation. For example, in step 101, the first gesture operation inputted by the user is acquired, in step 102, if it is judged that the first gesture operation is a first preset gesture operation, a selection interface of menu items corresponding to the first preset gesture operation is displayed, a preset menu item is determined as a target menu item, and a display state of the target menu item is set to be a selected state; and if the first gesture operation is judged as a second preset gesture operation, a selection interface of menu items corresponding to the second preset gesture operation is displayed, a preset menu item is determined as a target menu item, and a display state of the target menu item is set to be a selected state. In this way, the user can determine to enter the different selection interfaces of menu items by inputting different preset gesture operations.

In addition to a background color burn state as shown in FIG. 2b, the selected state may be a selected state in any form, for example, may be a state where a color and/or font of text in the target menu item are changed, or may be a state where a frame is added to the target menu item, and the like. A specific display form of the selected state is not limited in the present disclosure.

In step 103, acquiring a second gesture operation inputted by the user after the first gesture operation.

In step 104, determining the target menu item according to a gesture trajectory in the second gesture operation.

After determining that the user needs to select a menu item, the second gesture operation of the user is continuously acquired, so that the target menu item need to be selected by the user can be determined from a plurality of menu items according to the gesture trajectory of the second gesture operation.

The method of determining the target menu item according to the acquired second gesture operation may be various, for example, in the selection interface of menu items, the target menu item is moved to the left by one column from the current position, that is, the menu item on the left side of the current target menu item is determined to be a new target menu item, or, a third preset gesture operation for characterizing that the target menu item is moved to the left may be set, and when the acquired second gesture operation meets a condition of the third preset gesture operation, the menu item on the left side of the current target menu item is determined to be a new menu item. The operations of moving the target menu item from the current position to the right, up, down and the like can be respectively set with a corresponding fourth preset gesture operation, a corresponding fifth preset gesture operation, a corresponding sixth preset gesture operation and the like according to the above method. A specific preset gesture operation is not limited in the present disclosure.

The method of determining the target menu item according to the acquired second gesture operation may also be other methods, and the method of determining the target menu item according to the second gesture operation is not limited in the present disclosure either, as long as the target menu item can be selected according to the second gesture operation inputted by the user and characterizing the intention of the user.

By means of the above technical solutions, the selection of menu item can be started directly according to a preset gesture operation inputted by the user at any position on the screen, and the target menu item can be selected from a plurality of menu items according to a subsequently inputted second gesture operation, so that the problem that the selection of the menu item is not inconvenient to operate due to the influence of the size of the screen and the display position of the menu item can be avoided, which greatly facilitates the selection of the menu item by the user in various application scenarios and with various screen sizes.

In a possible implementation, the gesture trajectory between the second gesture operation and the first gesture operation is a continuous trajectory. That is, after determining that the first gesture operation is the preset gesture operation, the user needs to continuously press or swipe the screen to input the second gesture operation. Only a gesture operation after the preset gesture operation and in the same continuous trajectory as the preset gesture operation can be determined as the second gesture operation. In this way, it can be further ensured that the acquired second gesture operation is the gesture operation inputted by the user for selecting a menu item in the selection interface of menu items.

In one possible implementation, the determining the target menu item according to the gesture trajectory in the second gesture operation comprises: determining a moving direction and a moving distance of the gesture trajectory in real time according to the second gesture operation; and updating the target menu item in real time according to the moving direction and the moving distance, and setting the display state of the updated target menu item to be a selected state. For example, under the condition that it is determined that the moving direction of the gesture trajectory of the second gesture operation is within a direction range of a first preset direction, and the moving direction is kept to continuously move for more than a first preset distance or continuously move for more than a second preset duration, a first menu item in the first preset direction of the current target menu item is determined as a new target menu item; and under the condition that the moving direction of the gesture trajectory of the second gesture operation is determined to be within a direction range of a second preset direction, and the moving direction is kept to continuously move beyond the first preset distance or continuously move beyond the second preset duration, a first menu item in the second preset direction of the current target menu item is determined as a new target menu item. The first predetermined direction may be, for example, a left side, and the second predetermined direction may be, for example, a right side.

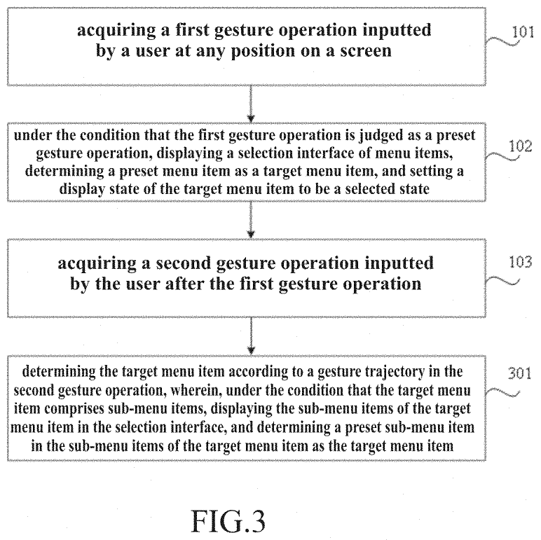

FIG. 3 is a flow diagram illustrating a menu item selection method according to yet another exemplary embodiment of the present disclosure. As shown in FIG. 3, the method comprises step 301 in addition to steps 101 to 103 shown in FIG. 1.

In step 301, the target menu item is determined according to the gesture trajectory in the second gesture operation, wherein when the target menu item includes sub-menu items, the sub-menu items of the target menu item are displayed in the selection interface, and a preset sub-menu item in the sub-menu items of the target menu item is determined as the target menu item.

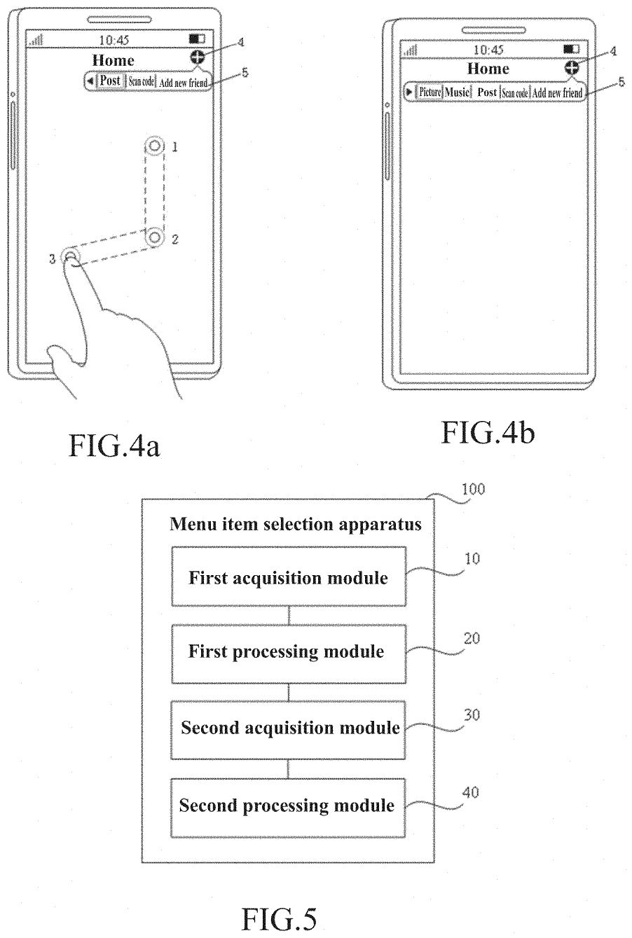

An example is given below in conjunction with FIGS. 4a and 4b to describe the step 301 above.

As shown in FIG. 4a, after the user inputs the preset gesture operation from the contact point 1 to the contact point 2 as shown in FIG. 2a, the selection interface 5 of menu items is displayed on the screen, and the preset menu item “post” therein is determined as the target menu item, and the display state thereof is accordingly set to a selected state. At this time, the user keeps pressing on the contact point 2, and inputs a second gesture operation from the contact point 2 to a contact point 3, a moving direction of the gesture trajectory is on the left side relative to the contact point 2, and a distance of the gesture trajectory is greater than the first preset distance, then it may be determined according to the second gesture operation that the current target menu item should move to the left side by one column, that is, it may be determined that the menu item “ [symbol] ” on the left side of the menu item “post” is the updated target menu item, and the display state of the menu item “ [symbol] ” is set to be a selected state. However, since sub-menu items are also included in the menu item “ [symbol] ”, when the menu item “ [symbol] ” is determined as the target menu item, the selection interface 5 of menu items will be displayed as shown in FIG. 4b, that is, the sub-menu item “picture” and the sub-menu item “music” of the menu item “ [symbol] ” are displayed in the selection interface 5 of menu items, and the preset sub-menu item “picture” is determined as the target menu item, and the display state thereof is set to be a selected state.

In addition, after the sub-menu items of the menu item are displayed in the selection interface 5 of menu items, the selection of all the sub-menu items and other menu items is in the same manner as before the sub-menu items are not displayed on the selection interface 5 of menu items, the selection of the target menu item can be performed according to the second gesture operation inputted by the user.

The target menu item when the user stops inputting the second gesture operation is the menu item selected by the user.

In one possible embodiment, the method further comprises: once the first gesture operation is judged to be the preset gesture operation, displaying first prompt information on the screen, wherein the first prompt information is used for prompting that currently the selection of the menu item has been entered, and the user can continue to input the second gesture operation to select from a plurality of menu items in the selection interface of menu items. For example, the first prompt message may be: moving the selected menu item, releasing the selected current menu item, etc.

FIG. 5 is a structural block diagram illustrating a menu item selection apparatus 100 according to an exemplary embodiment of the present disclosure. As shown in FIG. 5, the apparatus 100 comprises: a first acquisition module 10 configured to acquire a first gesture operation inputted by a user at any position on a screen; a first processing module 20 configured to, under the condition that the first gesture operation is judged as a preset gesture operation, display a selection interface of menu items, determine a preset menu item as a target menu item, and set a display state of the target menu item to be a selected state; a second acquisition module 30 configured to acquire a second gesture operation inputted by the user after the first gesture operation; and a second processing module 40 configured to determine the target menu item according to a gesture trajectory in the second gesture operation.

By means of the above technical solutions, the selection of menu item can be started directly according to a preset gesture operation inputted by the user at any position on the screen, and the target menu item can be selected from a plurality of menu items according to a subsequently inputted second gesture operation, so that the problem that the selection of the menu item is not inconvenient to operate due to the influence of the size of the screen and the display position of the menu item can be avoided, which greatly facilitates the selection of the menu item by the user in various application scenarios and with various screen sizes.

In one implementation, the preset gesture operation is that: a swiping distance in a screen preset direction is within a first preset distance range, and after swiping is stopped, a continuous pressing time at a position where swiping is stopped exceeds a first preset duration.

In one implementation, a gesture trajectory between the second gesture operation and the first gesture operation is a continuous trajectory.

In a possible implementation, the second processing module 40 comprises: a first processing submodule configured to determine a moving direction and a moving distance of the gesture trajectory in real time according to the second gesture operation; and a second processing sub-module configured to update the target menu item in real time according to the moving direction and the moving distance, and set the display state of the updated target menu item to be a selected state.

In a possible implementation, the second processing module 40 further comprises: a third processing sub-module configured to display sub-menu items of the target menu item in the selection interface under the condition that the target menu item comprises the sub-menu items, and determine a preset sub-menu item in the sub-menu items of the target menu item as the target menu item.

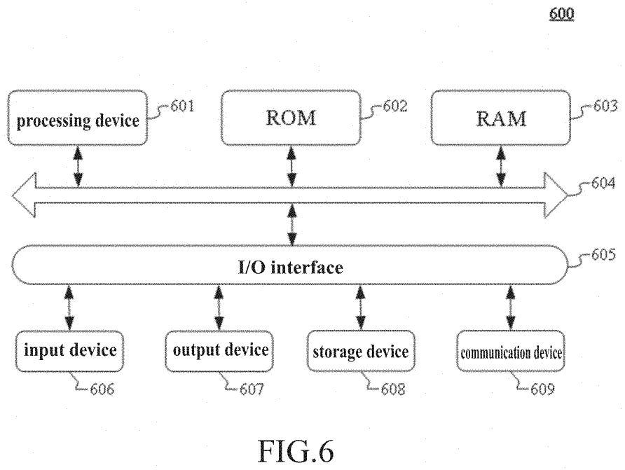

Reference is now made to FIG. 6 below, which shows a schematic structural diagram of an electronic device 600 suitable for implementing the embodiment of the present disclosure. The terminal device in the embodiment of the present disclosure can comprise, but is not limited to, a mobile terminal such as a mobile phone, a notebook computer, a digital broadcast receiver, a PDA (personal digital assistant), a PAD (tablet computer), a PMP (portable multimedia player), a vehicle-mounted terminal (for example, a vehicle-mounted navigation terminal), and the like, and a fixed terminal such as a digital TV, a desktop computer, and the like. The electronic device shown in FIG. 6 is only one example, and should not bring any limitation to the function and the scope of use of the embodiment of the present disclosure.

As shown in FIG. 6, the electronic device 600 can comprise a processing device (for example, a central processing unit, a graphics processor, etc.) 601 that can perform various appropriate actions and processing according to a program stored in a read-only memory (ROM) 602 or a program loaded from a storage device 608 into a random access memory (RAM) 603. In the RAM 603, various programs and data required for the operation of the electronic device 600 are also stored. The processing device 601, the ROM 602, and the RAM 603 are connected to each other through a bus 604. An input/output (I/O) interface 605 is also connected to the bus 604.

Generally, the following devices can be connected to the I/O interface 605: an input device 606 comprising, for example, a touch screen, touch pad, keyboard, mouse, camera, microphone, accelerometer, gyroscope, etc.; an output device 607 comprising, for example, a liquid crystal display (LCD), a speaker, a vibrator, etc.; a storage device 608 comprising, for example, a magnetic tape, a hard disk, etc.; and a communication device 609. The communication device 609 can allow the electronic device 600 to communicate with other devices wirelessly or by wire to exchange data. While FIG. 6 illustrates the electronic device 600 having various devices, it should be understood that not all illustrated devices are required to be implemented or provided. More or fewer devices can be alternatively implemented or provided.

In particular, according to the embodiments of the present disclosure, the process described above with reference to the flow diagram can be implemented as a computer software program. For example, the embodiment of the present disclosure comprises a computer program product comprising a computer program carried on a non-transitory computer-readable medium, the computer program containing program code for performing the method illustrated by the flow diagram. In such an embodiment, the computer program can be downloaded and installed from a network via the communication device 609, or installed from the storage device 608, or installed from the ROM 602. The computer program, when executed by the processing device 601, performs the above function defined in the method of the embodiment of the present disclosure.

It should be noted that the above computer-readable medium of the present disclosure can be a computer-readable signal medium or a computer-readable storage medium or any combination of the above two. The computer-readable storage medium can be, for example, but is not limited to, an electronic, magnetic, optical, electromagnetic, infrared, or semiconductor system, apparatus, or device, or any combination of the above. More specific examples of the computer-readable storage medium can comprise, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium can be any tangible medium that can have thereon contained or stored a program for use by or in conjunction with an instruction execution system, apparatus, or device. However, in the present disclosure, the computer-readable signal medium can comprise a data signal propagated in baseband or as part of a carrier wave, in which computer-readable program code is carried. Such a propagated data signal can take a variety of forms that comprise, but are not limited to, an electro-magnetic signal, an optical signal, or any suitable combination of the above. The computer-readable signal medium can also be any computer-readable medium other than a computer-readable storage medium, which can send, propagate, or transport a program for use by or in conjunction with an instruction execution system, apparatus, or device. The program code contained on the computer-readable medium can be transmitted using any appropriate medium, which comprises but is not limited to: a wire, an optical cable, RF (radio frequency), etc., or any suitable combination of the above.

In some embodiments, communication can be made using any currently known or future developed network protocol, such as HTTP (HyperText Transfer Protocol), and interconnection can be made with any form or medium of digital data communication (for example, a communication network). Examples of the communication network comprise a local area network (“LAN”), a wide area network (“WAN”), an internet (for example, the Internet), and a peer-to-peer network (for example, ad hoc peer-to-peer network), as well as any currently known or future developed network.

The above computer-readable medium can be contained in the electronic device; and can also exist alone and not be assembled into the electronic device.

The above computer-readable medium has thereon carried one or more programs which, when executed by the electronic device, cause the electronic device to: acquire a first gesture operation inputted by a user at any position on a screen; under the condition that the first gesture operation is judged as a preset gesture operation, display a selection interface of menu items, determine a preset menu item as a target menu item, and set a display state of the target menu item to be a selected state; acquire a second gesture operation inputted by the user after the first gesture operation; and determine the target menu item according to a gesture trajectory in the second gesture operation.

Computer program code for performing operations of the present disclosure can be written in one or more programming languages or any combination thereof, wherein the programming language comprises but is not limited to an object-oriented programming language such as Java, Smalltalk, C++, and further comprises a conventional procedural programming language, such as the “C” programming language or a similar programming language. The program code can be executed entirely on a user's computer, partly on the user's computer, as a stand-alone software package, partly on the user's computer and partly on a remote computer or entirely on the remote computer or server. In a scene where the remote computer is involved, the remote computer can be connected to the user's computer through any type of network, which comprises a local area network (LAN) or a wide area network (WAN), or can be connected to an external computer (for example, through the Internet connection using an Internet service provider).

The flow diagrams and block diagrams in the accompanying drawings illustrate the possibly implemented architectures, functions, and operations of the systems, methods and computer program products according to various embodiments of the present disclosure. In this regard, each block in the flow diagrams or block diagrams can represent a module, a program segment, or a portion of code, which contains one or more executable instructions for implementing a specified logic function. It should also be noted that, in some alternative implementations, the functions noted in the blocks can occur in a different order from the order noted in the drawings. For example, two blocks shown in succession can, in fact, be executed substantially concurrently, or the blocks can sometimes be executed in a reverse order, which depends upon the functions involved. It will also be noted that each block of the block diagrams and/or flow diagrams, and a combination of blocks in the block diagrams and/or flow diagrams, can be implemented by a special-purpose hardware-based system that performs the specified function or operation, or by a combination of special-purpose hardware and computer instructions.

Involved modules described in the embodiments of the present disclosure can be implemented by software or hardware. A name of the unit, in some cases, does not constitute a limitation on the module itself, for example, the first acquisition module can also be described as “a first gesture operation inputted by the user at any position on a screen”.

The functions described above herein can be performed, at least in part, by one or more hardware logic components. For example, without limitation, an exemplary type of hardware logic components that can be used comprises: a field programmable gate array (FPGA), an application specific integrated circuit (ASIC), an application specific standard product (ASSP), a system on chip (SOC), a complex programmable logic device (CPLD), and the like.

In the context of this disclosure, the machine-readable medium can be a tangible medium that can have thereon contained or stored a program for use by or in conjunction with an instruction execution system, apparatus, or device. The machine-readable medium can be a machine-readable signal medium or a machine-readable storage medium. The machine-readable medium can comprise, but is not limited to, an electronic, magnetic, optical, electromagnetic, infrared, or semiconductor system, apparatus, or device, or any suitable combination of the above. More specific examples of the machine-readable storage medium would comprise an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, an example 1 provides a menu item selection method, comprising: acquiring a first gesture operation inputted by a user at any position on a screen; under the condition that the first gesture operation is judged as a preset gesture operation, displaying a selection interface of menu items, determining a preset menu item as a target menu item, and setting a display state of the target menu item to be a selected state; acquiring a second gesture operation inputted by the user after the first gesture operation; and determining the target menu item according to a gesture trajectory in the second gesture operation.

According to one or more embodiments of the present disclosure, an example 2 provides the method of the example 1, wherein the preset gesture operation is that: a swiping distance in a screen preset direction is within a first preset distance range, and after swiping is stopped, a continuous pressing time at a position where swiping is stopped exceeds a first preset duration.

According to one or more embodiments of the present disclosure, an example 3 provides the method of the example 1, wherein a gesture trajectory between the second gesture operation and the first gesture operation is a continuous trajectory.

According to one or more embodiments of the present disclosure, an example 4 provides the method of any of the examples 1-3, wherein the determining the target menu item according to the gesture trajectory in the second gesture operation comprises: determining a moving direction and a moving distance of the gesture trajectory in real time according to the second gesture operation; and updating the target menu item in real time according to the moving direction and the moving distance, and setting the display state of the updated target menu item to be a selected state.

According to one or more embodiments of the present disclosure, an example 5 provides the method of any of the examples 1-3, wherein, the determining the target menu item according to the gesture trajectory in the second gesture operation comprises: under the condition that the target menu item comprises sub-menu items, displaying the sub-menu items of the target menu item in the selection interface, and determining a preset sub-menu item in the sub-menu items of the target menu item as the target menu item.

According to one or more embodiments of the present disclosure, an example 6 provides a menu item selection apparatus, comprising: a first acquisition module configured to acquire a first gesture operation inputted by a user at any position on a screen; a first processing module configured to, under the condition that the first gesture operation is judged as a preset gesture operation, display a selection interface of menu items, determine a preset menu item as a target menu item, and set a display state of the target menu item to be a selected state; a second acquisition module configured to acquire a second gesture operation inputted by the user after the first gesture operation; and a second processing module configured to determine the target menu item according to a gesture trajectory in the second gesture operation.

According to one or more embodiments of the present disclosure, an example 7 provides the apparatus of the example 6, wherein the preset gesture operation is that: a swiping distance in a screen preset direction is within a first preset distance range, and after swiping is stopped, a continuous pressing time at a position where swiping is stopped exceeds a first preset duration.

According to one or more embodiments of the present disclosure, an example 8 provides the apparatus of the example 6, wherein a gesture trajectory between the second gesture operation and the first gesture operation is a continuous trajectory.

According to one or more embodiments of the present disclosure, an example 9 provides a computer readable medium having stored thereon a computer program which, when executed by a processing device, performs the steps of the method as described in any of the examples 1-5.

According to one or more embodiments of the present disclosure, an example 10 provides an electronic device, comprising: a storage device having a computer program stored thereon; a processing device configured to execute the computer program in the storage device to implement the steps of the method as described in any of the examples 1-5.

The foregoing description is only illustrative of preferred embodiments of the present disclosure and the applied technical principles thereof. It should be appreciated by those skilled in the art that the scope involved in the present disclosure is not limited to the technical solution formed by the specific combination of the above technical features, but should also encompass other technical solutions formed by arbitrary combinations of the above technical features or equivalent features thereof without departing from the concepts of the disclosure. For example, a technical solution formed by replacing the above features with technical features having similar functions disclosed (but not limited to) in the present disclosure.

Furthermore, while operations are depicted in a specific order, this should not be understood as requiring that such operations be performed in the specific order shown or in a sequential order. Under certain circumstances, multitasking and parallel processing maybe advantageous. Similarly, while several specific implementation details are contained in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination. Although the subject matter has been described in language specific to structural features and/or method logic actions, it should be understood that the subject matter defined in the attached claims is not necessarily limited to the specific features or actions described above. Conversely, the specific features and actions described above are only example forms in which the claims are implemented. Regarding the apparatus in the above embodiments, the specific implementations of the operations executed by the various modules have been described in detail in the method embodiments, and thus are not described in detail here.

1. A menu item selection method, comprising:
acquiring a first gesture operation inputted by a user at any position on a screen;
under the condition that the first gesture operation is judged as a preset gesture operation, displaying a selection interface of menu items, determining a preset menu item as a target menu item, and setting a display state of the target menu item to be a selected state;
acquiring a second gesture operation inputted by the user after the first gesture operation; and
determining the target menu item according to a gesture trajectory in the second gesture operation.

2. The method according to claim 1, wherein the preset gesture operation is that:
a swiping distance in a screen preset direction is within a first preset distance range, and after swiping is stopped, a continuous pressing time at a position where swiping is stopped exceeds a first preset duration.

3. The method according to claim 1, wherein a gesture trajectory between the second gesture operation and the first gesture operation is a continuous trajectory.

4. The method according to claim 1, wherein the determining the target menu item according to the gesture trajectory in the second gesture operation comprises:
determining a moving direction and a moving distance of the gesture trajectory in real time according to the second gesture operation; and
updating the target menu item in real time according to the moving direction and the moving distance, and setting the display state of the updated target menu item to be a selected state.

5. The method according to claim 1, wherein the determining the target menu item according to the gesture trajectory in the second gesture operation comprises:
under the condition that the target menu item comprises sub-menu items, displaying the sub-menu items of the target menu item in the selection interface, and determining a preset sub-menu item in the sub-menu items of the target menu item as the target menu item.

6. The method according to claim 1, wherein the method further comprises:
once the first gesture operation is judged as the preset gesture operation, displaying first prompt information on the screen, wherein the first prompt information is used for prompting the user that currently the selection of the menu item has been entered, and the user can continue to input the second gesture operation to select from a plurality of menu items in the selection interface of menu items.

7. The method according to claim 1, wherein if there are multiple selection interfaces of menu items, multiple different preset gesture operations are set to correspond to the different selection interfaces of menu items one to one.

8. A menu item selection apparatus, comprising:
a first acquisition module configured to acquire a first gesture operation inputted by a user at any position on a screen;
a first processing module configured to, under the condition that the first gesture operation is judged as a preset gesture operation, display a selection interface of menu items, determine a preset menu item as a target menu item, and set a display state of the target menu item to be a selected state;
a second acquisition module configured to acquire a second gesture operation inputted by the user after the first gesture operation; and
a second processing module configured to determine the target menu item according to a gesture trajectory in the second gesture operation.

9. The apparatus according to claim 8, wherein the preset gesture operation is that: a swiping distance in a screen preset direction is within a first preset distance range, and after swiping is stopped, a continuous pressing time at a position where swiping is stopped exceeds a first preset duration.

10. The apparatus according to claim 8, wherein a gesture trajectory between the second gesture operation and the first gesture operation is a continuous trajectory.

11. A non-transitory computer readable medium having stored thereon a computer program which, when executed by a processing device, performs the steps of:
acquiring a first gesture operation inputted by a user at any position on a screen;
under the condition that the first gesture operation is judged as a preset gesture operation, displaying a selection interface of menu items, determining a preset menu item as a target menu item, and setting a display state of the target menu item to be a selected state;
acquiring a second gesture operation inputted by the user after the first gesture operation; and
determining the target menu item according to a gesture trajectory in the second gesture operation.

12. An electronic device, comprising:
a storage device having a computer program stored thereon;
a processing device configured to execute the computer program in the storage device to implement the steps of the method according to claim 1.

13. A computer program comprising program code for performing the method according to claim 1 when said computer program is run by a computer.

14. The non-transitory computer readable medium according to claim 11, wherein the preset gesture operation is that:
a swiping distance in a screen preset direction is within a first preset distance range, and after swiping is stopped, a continuous pressing time at a position where swiping is stopped exceeds a first preset duration.

15. The non-transitory computer readable medium according to claim 11, wherein a gesture trajectory between the second gesture operation and the first gesture operation is a continuous trajectory.

16. The non-transitory computer readable medium according to claim 11, wherein the determining the target menu item according to the gesture trajectory in the second gesture operation comprises:
determining a moving direction and a moving distance of the gesture trajectory in real time according to the second gesture operation; and
updating the target menu item in real time according to the moving direction and the moving distance, and setting the display state of the updated target menu item to be a selected state.

17. The non-transitory computer readable medium according to claim 11, wherein the determining the target menu item according to the gesture trajectory in the second gesture operation comprises:
under the condition that the target menu item comprises sub-menu items, displaying the sub-menu items of the target menu item in the selection interface, and determining a preset sub-menu item in the sub-menu items of the target menu item as the target menu item.

18. The non-transitory computer readable medium according to claim 11, wherein the computer program, when executed by the processing device, further performs the step of:
once the first gesture operation is judged as the preset gesture operation, displaying first prompt information on the screen, wherein the first prompt information is used for prompting the user that currently the selection of the menu item has been entered, and the user can continue to input the second gesture operation to select from a plurality of menu items in the selection interface of menu items.

19. The non-transitory computer readable medium according to claim 11, wherein if there are multiple selection interfaces of menu items, multiple different preset gesture operations are set to correspond to the different selection interfaces of menu items one to one.
